(19) United States
(12) Patent Application Publication
(10) Pub. No.: US 2026/0009711 A1
(43) Pub. Date: Jan. 8, 2026

(54) MECHANICAL RESONATOR FOR USE IN A SYSTEM FOR MEASURING A PROPERTY OF A PARTICLE

(71) Applicant: COMMISSARIAT A L'ÉNERGIE ATOMIQUE ET AUX ENERGIES ALTERNATIVES, Paris (FR)

(72) Inventors: Loïc JOET, Grenoble Cedex 09 (FR); Vincent AGACHE, Grenoble Cedex 09 (FR); Laurent MOLLARD, Grenoble Cedex 09 (FR); Fanny DELAGUILLAUMIE, Grenoble Cedex 09 (FR)

(73) Assignee: COMMISSARIAT A L'ÉNERGIE ATOMIQUE ET AUX ENERGIES ALTERNATIVES, Paris (FR)

(21) Appl. No.: 19/260,788

(22) Filed: Jul. 7, 2025

(30) Foreign Application Priority Data
Jul. 8, 2024 (FR) FR2407444

(51) Int. Cl. G01N 9/00

(52) U.S. Cl. CPC G01N 9/002; G01N 2009/006

(57) ABSTRACT

A mechanical resonator for use in a system for measuring a property of a particle, including a body having an oscillating part capable of vibrating in relation to an anchor in a transverse plane and a fluidic channel that is integrated in its oscillating part and in which a fluid containing the particle is circulated. The mechanical resonator has a hinge mechanism created between the oscillating part and the anchor, a strain gauge, of the suspended type, configured to measure the deformation of the oscillating part when it is vibrating.

### TECHNICAL FIELD OF THE INVENTION

The present invention relates to a mechanical resonator for use in a system for measuring a property of a particle and in a corresponding system.

### PRIOR ART

To detect the presence of biomarkers of interest such as proteins, exosomes, circulating RNA, circulating DNA, viruses or larger target species such as bacteria and cells, it is known to use biosensors.

Biosensors include notably the category of gravimetric sensors. These are based on the use of a mechanical oscillator or resonator equipped with an oscillating part comprising a suspended beam or plate that is vibrated according to one of its resonance modes. Any target that grafts to the surface of the resonator causes the mass thereof to increase, thereby reducing the resonant frequency by a shift linked to the mass of the captured target.

By continuously measuring the fluctuations in resonant frequency, it is then possible to work out the mass adsorbed on the resonator in real time and for example to thus monitor adsorption kinetics with targets.

One solution proposed in the prior art consists in integrating and defining a fluidic channel within the resonator, while said resonator oscillates in a fluid-free cavity. The advantage then lies in a quality factor that is altered very little, even in the presence of fluid circulating in the oscillator, and thus in an optimized detection limit. This type of resonator is commonly called an SMR (suspended microchannel resonator) or an SNR (suspended nanochannel resonator), depending on the dimensions of its fluidic channel. It may be noted that a resonator equipped with a fluidic channel the width or thickness of which is less than 1 μm will be referred to as an SNR, otherwise it will be an SMR.

By virtue of a pressure gradient imposed between a fluidic inlet and a fluidic outlet of the circuit, it is possible to control the flow of the fluid (its flow rate and flow direction), and therefore the passage of suspended particles through the SMR (or SNR). This type of sensor has been used for various applications, including the individual weighing of biological particles such as cells, bacteria, nanoparticles, or the detection of specific proteins through the prior functionalization of the internal walls of the SMR. This operating principle is now well known. Patent application US2021/046477A1 and patents U.S. Pat. Nos. 8,899,102B1, 8,631,685B2 and 8,312,763B2 describe this type of sensor.

Documents US2021/046477A1 and U.S. Pat. No. 8,899,102B2, for their part, describe conventional SMR solutions.

In these prior solutions, measurement of the deformation of the suspended beam can be accomplished by various means:
capacitive means,
optical means,
piezoresistive means.

Measurement by piezoresistive means has many advantages. Gauges are inexpensive, easy to install and allow for multi-channel reading.

Conventionally, the gauge is implanted directly in the upper membrane of the body of the resonator, by doping (localized doping by ion implantation). It thus follows the deformation of the oscillating part when it is vibrating.

It has been found that in existing structures (see referenced publication Suspended Nanochannel Resonator Arrays with Piezoresistive Sensors for High-Throughput Weighing of Nanoparticles in Solution—Marco Gagino, Georgios Katsikis, Selim Olcum, Leopold Virot, Martine Cochet, Aurélie Thuaire, Scott R. Manalis, and Vincent Agache—ACS Sensors 2020 5 (4), 1230-1238—DOI: 10.1021/acssensors.0c00394), where the gauge is thus directly implanted, the electrical reading limits the performance of the device. In other words, the signal-to-noise ratio is too low and, notably, lower than that obtained by comparison via an optical reading (for example by illuminating a photodiode with a laser reflected from the SNR in oscillation). This can be explained by a low amplitude of the piezoresistive signal (variation of the resistance) owing to the chosen configuration (ion implantation in the upper membrane of the resonator over a very small thickness compared to the total thickness of the body of the resonator that deforms). In addition, we observed a deterioration of the signal-to-noise ratio with regard to the conductivity level of the fluid circulating in the channel of the resonator, due to insufficient insulation with the piezoresistor confined to the upper membrane of the resonator.

A similar architecture is presented in the referenced publication “Suspended microchannel resonators with piezoresistive sensors”—Lab on Chip—vol. 11, No 4, January 2011—page 645, XP055155323; ISSN: 1473-0197, DOI: 10.1039/C0LC0047B.

The aim of the invention is to obtain a resonator of the SMR or SNR type that uses piezoresistivity measurement and in which the maximum energy related to the deformation of the oscillating part of the resonator is concentrated on the strain gauge, thus increasing the amplitude of the signal and therefore improving the signal-to-noise ratio.

### DESCRIPTION OF THE INVENTION

This aim is achieved by a mechanical resonator for use in a system for measuring a property of a particle, the mechanical resonator comprising:
a body having an oscillating part capable of vibrating in relation to anchor means of the mechanical resonator, in a transverse plane, and a fluidic channel that is integrated in its oscillating part and in which a fluid containing said particle is circulated,
a hinge mechanism created between the oscillating part and the anchor means,
the oscillating part having a suspended beam extending as a cantilever along a longitudinal axis and two lateral beams holding said suspended beam, said fluidic channel being provided through said lateral beams and the suspended beam,
the hinge mechanism having:
at least one first mechanical and electrical joining element that forms a first bridge joining the oscillating part to a first anchor part of the anchor means, said first joining element being deformable in bending,
torsion blades formed by side walls of the fluidic channel in each lateral beam,
the mechanical resonator having:
a strain gauge, of the suspended type, configured to measure the deformation of the oscillating part when it is vibrating, the strain gauge being arranged to form a second suspended bridge between a second anchor part of the anchor means and the oscillating part.

According to another distinctive feature, the first bridge and the second bridge are produced in two separate parallel planes perpendicular to the transverse vibrational plane of the oscillating part.

According to another distinctive feature, the resonator has:
an electrical circuit formed between a first electrical contact area and a second electrical contact area, between which an electrical signal is intended to be measured,
the first electrical contact area being located on the first anchor part,
the second electrical contact area being located on the second anchor part,
the electrical circuit being arranged between the first electrical contact area and the second electrical contact area via the first joining element, the oscillating part and the strain gauge.

According to another distinctive feature, the resonator has a second mechanical and electrical joining element, which is arranged symmetrically with respect to the first joining element about the longitudinal axis and forms a third bridge joining the oscillating part to a third anchor part, said second joining element also being deformable in bending to contribute to forming said hinge mechanism for the vibrational movement of the oscillating part.

According to another distinctive feature, the first anchor part and the third anchor part form part of the body of the mechanical resonator.

According to another distinctive feature, the body has two interstices produced on either side of the longitudinal axis, which are hollowed out over its entire thickness, each interstice being formed so as to leave the first mechanical joining element and said second joining element, respectively, between the oscillating part and their respective anchor part.

According to another distinctive feature, the body of the resonator is produced by an assembly of multiple superposed layers.

According to another distinctive feature, each electrical contact area is produced by metallization on a layer of the body of the resonator.

The invention relates to a system for measuring a property of a particle, comprising:
a mechanical resonator comprising an oscillating part,
excitation means configured to vibrate the oscillating part at an excitation frequency,
means for measuring an electrical signal at the output of the mechanical resonator,
the mechanical resonator being as defined above.

According to one distinctive feature, the excitation means have a piezoceramic on which the mechanical resonator rests.

### BRIEF DESCRIPTION OF THE FIGURES

Other features and advantages will become apparent in the detailed description that follows, which is given with reference to the figures listed below:

FIG. 1 shows a diagram illustrating the principle of implementation of the measurement system of the invention;

FIG. 2 shows a perspective view of the mechanical resonator used in the system of the invention, according to an advantageous embodiment;

FIG. 3 shows a view from above of the mechanical resonator of FIG. 2;

FIG. 4 shows a longitudinal sectional view along C1 of the mechanical resonator of FIG. 3.

### DETAILED DESCRIPTION OF AT LEAST ONE EMBODIMENT

The invention relates notably to a system used to measure at least one property (for example mass, volume, density) of a particle. A particle is understood to mean for example a biological particle such as a cell, exosome, virus, bacterium, etc. A particle is also understood to mean an inorganic particle such as for example a gold particle, polystyrene particle, etc.

For the remainder of the description, an orthonormal reference system (X, Y, Z) is defined, the plane (X, Y) being defined as a horizontal plane.

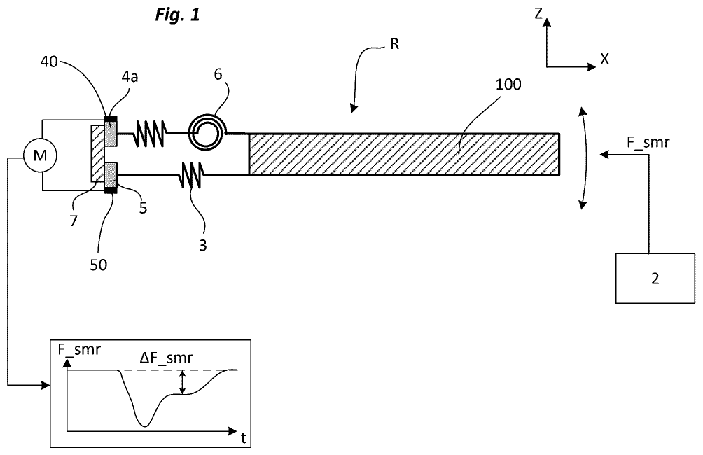

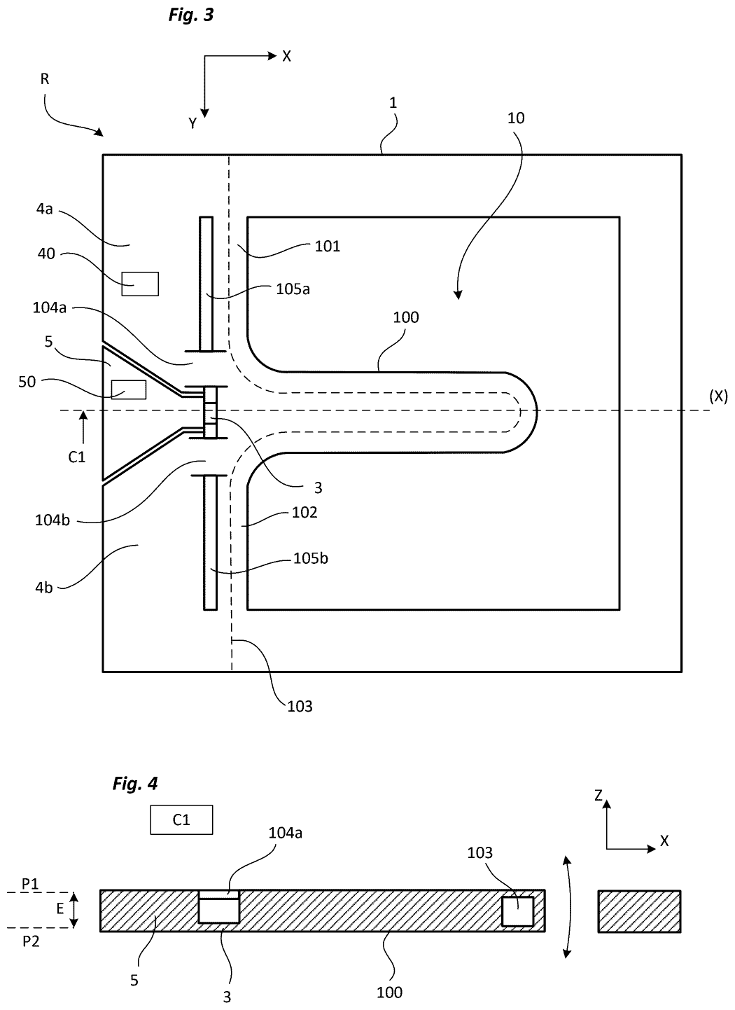

Referring to FIGS. 1 to 4, the measurement system has a mechanical resonator (referenced R in the appended figures), better known as an SMR (Suspended Microchannel Resonator) or SNR (Suspended Nanochannel Resonator), its micro or nano character depending notably on the dimensions of its integrated fluidic channel. A resonator equipped with a fluidic channel the width or thickness of which is less than 1 μm will be referred to as an SNR, otherwise it will be an SMR.

In the context of the invention, the resonator R has a body 1.

The body 1 has an oscillating part 10. The oscillating part 10 has a suspended beam 100 extending as a cantilever along a longitudinal axis (along X) and two lateral beams 101, 102 holding said suspended beam. The two lateral beams 101, 102 and the suspended beam 100 are arranged to form a T.

The oscillating part 10 has an integrated fluidic channel 103 that starts with a fluidic inlet then extends inside the first lateral beam 101 by way of a first lateral section, continues inside the suspended beam 100 by way of an outgoing section, runs from its first lateral section to the free end of the suspended beam 100 and runs from the free end of the suspended beam 100 to a second lateral section by way of a returning section, the fluidic channel ending at a fluidic outlet via the second lateral section located across the second lateral beam 102.

The fluidic channel 103 is formed by sealed walls on the four faces (on top, underneath, to the side) and is intended to be used to inject a fluid into which are placed one or more particles to be characterized. The lateral beams 101, 102 and the suspended beam 100 of the oscillating part 10 therefore have the distinctive feature of being hollow to allow circulation of the fluid.

A mechanical resonator R of the SMR type can be used to circulate particles of larger sizes (than an SNR) in its fluidic channel 103, and to potentially analyse samples that are more complex (in terms of heterogeneity of the size of particles in suspension).

The system has excitation means 2 configured to vibrate the oscillating part 10 of the resonator R, and more particularly its suspended beam 100, at an excitation frequency F_smr. This excitation frequency is advantageously the frequency of a resonance mode of the resonator.

In this type of resonator R, the vibration is generally produced out of plane (as indicated by the curved arrow in FIG. 1). The out-of-plane vibration is produced in the direction (Z).

The oscillating part 10 is able to be vibrated so as to oscillate at the excitation frequency F_smr, this frequency advantageously being the resonant frequency in its fundamental natural mode or one of its higher natural modes, or even a combination of these modes.

It will be recalled that a mechanical resonator R such as this can be excited according to multiple vibration modes. For each vibration mode, the resonator has vibration nodes and vibration anti-nodes.

It will be recalled that a vibration anti-node corresponds to a region of the suspended part where the vibration amplitude is at a maximum for the invoked vibration mode.

By virtue of a pressure gradient imposed between the ports located upstream and downstream of the fluidic channel 103 integrated in the resonator R, it is possible to control the flow of the fluid (its flow rate and flow direction) in the fluidic channel 103, and therefore the passage of suspended particles through the fluidic channel of the mechanical resonator 1. When a particle circulates in the fluidic channel of the resonator, it transiently alters the mass (by Am) of the suspended beam 100 of the resonator R, resulting in a shift in its (resonant) frequency that is proportional to the floating mass of the particle. The floating mass of the particle is defined by the difference in mass between the particle and the mass of the carrier liquid for the same volume as that of the particle; if the particle has the same density as the carrier liquid, there is no difference in mass and the floating mass is zero.

Indeed, the shift in the frequency ΔF_smr (FIG. 1) of the resonator R depends on the added mass Δm, on the total mass m of the resonator and on a correction coefficient α, which depends specifically on the position of the added particle P, and on the resonance mode of the resonator (for example in bending), according to the following relationship:

$$\frac{Δ F\_smr}{F\_smr} = - ∝ \frac{Δ m}{m}$$

Thus, when a particle with a given floating mass Δm is injected into the fluidic channel 103 of the resonator R, this results in a maximum vibration amplitude when this particle is located at the vibration anti-node (for the vibration mode M_1 for example), and therefore a maximum frequency shift. It should be noted that, depending on the difference in density between the particle and the carrier fluid, the floating mass Δm will be positive (in the case of a denser particle) or negative (in the case of a less dense particle).

Actuation/excitation of the oscillating part 10 of the resonator R is advantageously accomplished by bringing a piezoceramic into contact with the rear face of the device in order to actuate the resonator SMR and its oscillating part 10, this piezoceramic playing the role of the aforementioned excitation means 2. The piezoceramic is, for example, bonded to a printed circuit board, which is itself designed to apply thereto an electrical potential that will deform the piezoelectric material. Vibration of the latter is accomplished by applying thereto, for example, an electrical signal at the resonant frequency of the resonator. It should be noted that the applied signal can collectively actuate multiple oscillating parts (multiple SMRs and/or multiple SNRs) arranged in parallel on the same component and the different resonance modes desired for each of them. In the latter case, the actuation signal applied to the piezoceramic has multiple frequencies.

Reading is accomplished using a strain gauge 3 operating by piezoresistive effect. The gauge 3 is configured to convert mechanical force into an electrical signal. As the compression of the gauge increases, its electrical resistance decreases. To this end, the gauge 3 is inserted into an electrical circuit (for example a Wheatstone bridge), the deformation of the gauge defining the electrical resistance of the electrical circuit.

The principle of the invention is shown schematically in FIG. 1. It consists in proposing a suitable mechanical arrangement for the resonator R in order to direct the maximum energy of the deformation of the oscillating part 10 and its suspended beam 100 towards the strain gauge 3. In other words, the intention is for the maximum mechanical deformation of the oscillating part 10 of the resonator R, when it is vibrating, to be concentrated on the strain gauge 3.

To this end, the invention consists in providing:
at least a first so-called anchor part 4a and a second so-called anchor part 5, which are separated from each other, without electrical connection between these two parts. These two anchor parts are mechanically connected to each other via the frame 7 (FIG. 1—the frame is chosen to be electrically insulating).
a hinge mechanism between the oscillating part and the anchor parts. This hinge mechanism is formed by:
   creating a first mechanical and electrical joining element 104a that is deformable in bending, this first joining element 104a forming a first bridge between the oscillating part 10 and the first anchor part 4a,
   using torsion blades produced by the lateral walls of the fluidic channel in the lateral beams 101 and 102 of the oscillating part 10.

According to one particular aspect of the invention, the strain gauge 3 is arranged to form a second suspended bridge between the oscillating part 10 and the fixed part 5.

According to one particular embodiment, a first electrical contact area 40 and a second electrical contact area 50 are created, between which an electrical signal M is read taking into account the resistance in the electrical circuit. The first electrical contact area 40 is advantageously located on the first anchor part 4a and the second electrical contact area 50 is advantageously located on the second anchor part 5.

The electrical circuit is produced between the first electrical contact area 40 and the second electrical contact area 50 via the first anchor part 4a, the first joining element 104a and/or the lateral beam 101, the oscillating part 10 of the resonator R, the strain gauge 3 and the second anchor part 5. Depending on the deformation undergone by the strain gauge 3, the resistance will be higher or lower and the measured electrical signal M will be varied.

The junction between the oscillating part 10 and the first anchor part 4a, via the first joining element 104a, and the junction between the oscillating part 10 and the second anchor part 5, via the strain gauge 3, are produced in two planes P1, P2 (FIG. 4) parallel to each other, along (X, Y), these two planes extending, for example, along the upper face of the body 1 of the resonator R and along the lower face of the body of the resonator R, respectively.

The hinge mechanism is created for the mechanical resonator R with a joining element 104a that, owing to its limited thickness (for example of the order of one hundred μm, with a thickness ratio of between 10 and 100, between the thickness of the beam and that of the joining element), is very flexible in bending (and very stiff in compression, notably much stiffer in compression than the strain gauge 3). The flexibility in bending created by the hinge mechanism causes low energy losses when the resonator is vibrating. The deformation is mainly taken up by the gauge.

And since the strain gauge 3 is suspended, the maximum energy of the deformation is transmitted to the strain gauge 3. Thus, it is the strain gauge that takes up most of the deformation of the oscillating part 10.

Advantageously, the strain gauge has an elongated shape and a reduced cross section, which gives it greater mechanical strength, increased resistance to constant-force stress and buckling resistance.

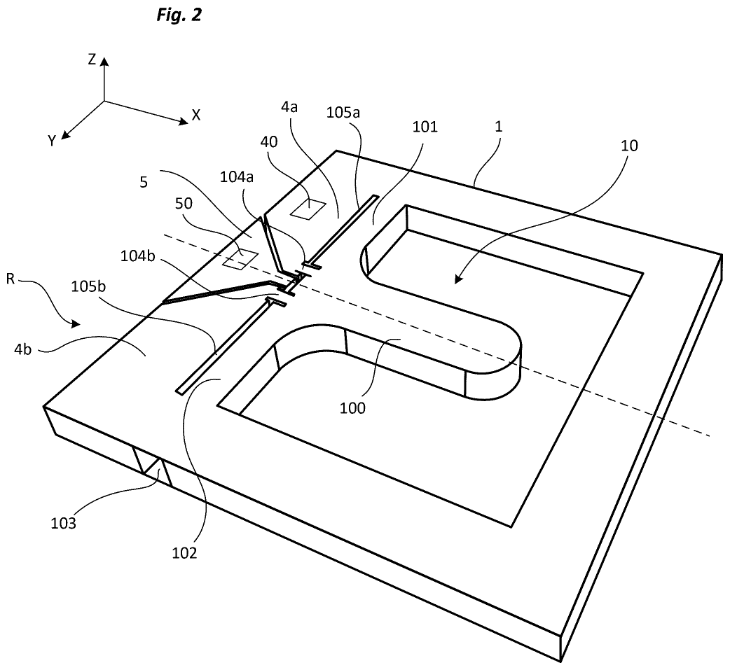

According to the embodiment of FIGS. 2 to 4, the body 1 of the resonator R has the first anchor part 4a and also a third anchor part, which is referenced 4b as it is advantageously identical to the first anchor part 4a described above. This third anchor part 4b is also mechanically connected to the frame 7.

The oscillating part 10 of the resonator R is connected to this third anchor part 4b by a second mechanical and electrical joining element 104b, which forms a second bridge that is symmetrical with respect to the first bridge.

The two joining elements 104a, 104b contribute to performing the function of the hinge 6 between the oscillating part 10 and the two anchor parts 4a, 4b, each in combination with the torsion blades formed by the lateral walls of the fluidic channel 103 in each lateral beam 101, 102. The two joining elements 104a, 104b are identical and contribute towards the hinge mechanism by being chosen to be very flexible in bending and very stiff in compression, stiffer in compression than the strain gauge 3, so as to transmit the maximum deformation energy from the oscillating part 10 to the strain gauge 3.

According to one particular aspect of the invention, in order to create the first joining element 104a and the second joining element 104b, two separate interstices 105a, 105b are hollowed out in the body 1 of the resonator R between each anchor part 4a, 4b and the oscillating part 10. Two different interstices 105a, 105b are thus obtained, which are produced symmetrically on either side of the longitudinal axis (along X). Each interstice 105a, 105b is produced so as to leave said joining element 104a, 104b between the anchor part 4a, 4b and the oscillating part 10 over a determined thickness, which is less than the thickness E of the layers (FIG. 4) that principally form the body 1 of the resonator R. The interstices are also created to form the lateral beams 101, 102 of the oscillating part 10, and therefore to help form the hinge mechanism.

Advantageously, the junction between the oscillating part 10 and each anchor part 4a, 4b, via each joining element 104a, 104b, and the junction between the oscillating part 10 and the fixed part 5, via the strain gauge 3, are produced in the aforementioned two parallel planes P1, P2, for example extending along the upper face of the body 1 of the resonator R and along the lower face of the body 1 of the resonator, respectively (FIG. 4).

Thus, when the oscillating part is vibrating, it is bent at each joining element 104a, 104b, contributing towards the hinge mechanism, together with the torsion blades mentioned above. The deformation is transmitted to the strain gauge 3 with a high signal-to-noise ratio, said strain gauge being suspended between the oscillating part 10 of the resonator R and the fixed part 5, the fixed part 5 being separate. In other words, the maximum mechanical deformation is thus transmitted to the strain gauge 3, making it possible to obtain a strong signal and thus to improve the final signal-to-noise ratio, by masking noise.

The electrical circuit produced between the two electrical contact areas 40, 50 is advantageously produced by uniform high doping for the entire body of the structure. The electrical circuit is produced by etching the silicon and mechanically cutting the tracks. Thus, depending on the level of deformation applied to the oscillating part 10, the resistance of the circuit running through the strain gauge 3 will be greater or lesser.

As indicated above, the oscillating part 10 is secured to the first anchor part 4a and the third anchor part 4b via its two lateral beams 101, 102. Thus, when it is being deformed, its lateral beams 101, 102 are deformed in torsion. These lateral beams 101, 102 are thus chosen to be flexible in torsion.

In a non-limiting manner, the body of the mechanical resonator R is advantageously produced by an assembly of multiple doped layers.

The electrical contact areas can be formed by metallization on the fixed part and the first anchor part.

The manufacturing process for the device uses standard MEMS/NEMS manufacturing technologies, by working on superposed layers:
photolithography of a NEMS layer present on an SOI (Silicon On Insulator) substrate to form the strain gauge 3,
deposition of a protective oxide on the NEMS layer,
photolithography of the protective oxide layer above the strain gauge 3 and the fluidic channel 103,
epitaxy of a thick silicon MEMS layer (for example 20 μm),
deep photolithography of the silicon MEMS layer to form the fluidic channel 103 and an opening for forming each mechanical joining element 104a, 104b,
bonding of a thin layer (for example a 500-nm SOI wafer) to close the fluidic channel 103 from above,
deep photolithography of the MEMS layer to trim the oscillating part 10, the fixed part 5 and etching of the edges of each joining element 104a, 104b,
isotopic chemical etching of the protective oxide layer to release the oscillating part 10,
metallization to create the electrical contact areas 40, 50.

1. A mechanical resonator for use in a system for measuring a property of a particle, the mechanical resonator comprising:
a body having an oscillating part capable of vibrating in relation to anchor means of the mechanical resonator, in a transverse plane, and a fluidic channel that is integrated in its oscillating part and wherein a fluid containing said particle is circulated,
a hinge mechanism created between the oscillating part and the anchor means,
the oscillating part having a suspended beam extending as a cantilever along a longitudinal axis and two lateral beams holding said suspended beam, said fluidic channel being provided through said lateral beams and the suspended beam,
wherein:
the hinge mechanism has:
at least one first mechanical and electrical joining element that forms a first bridge joining the oscillating part to a first anchor part of the anchor means, said first joining element being deformable in bending,
torsion blades formed by side walls of the fluidic channel in each lateral beam,
the mechanical resonator has:
a strain gauge, of the suspended type, configured to measure the deformation of the oscillating part when it is vibrating, the strain gauge being arranged to form a second suspended bridge between a second anchor part of the anchor means and the oscillating part.

2. The resonator according to claim 1, wherein:
the first bridge and the second bridge are produced in two separate parallel planes perpendicular to the transverse vibrational plane of the oscillating part.

3. The resonator according to claim 2, wherein a second mechanical and electrical joining element is arranged symmetrically with respect to the first joining element about the longitudinal axis and forms a third bridge joining the oscillating part to a third anchor part, said second joining element also being deformable in bending to contribute to forming said hinge mechanism for the vibrational movement of the oscillating part.

4. The resonator according to claim 3, wherein the first anchor part and the third anchor part form part of the body of the mechanical resonator.

5. The resonator according to claim 4, wherein the body has two interstices produced on either side of the longitudinal axis, which are hollowed out over its entire thickness, each interstice being formed so as to leave the first mechanical joining element and said second joining element, respectively, between the oscillating part and their respective anchor part.

6. The resonator according to claim 1, wherein:
an electrical circuit is formed between a first electrical contact area and a second electrical contact area, between which an electrical signal is intended to be measured,
the first electrical contact area is located on the first anchor part,
the second electrical contact area is located on the second anchor part,
the electrical circuit is arranged between the first electrical contact area and the second electrical contact area via the first joining element, the oscillating part and the strain gauge.

7. The resonator according to claim 6, wherein the body of the resonator is produced by an assembly of multiple superposed layers.

8. The resonator according to claim 7, wherein each electrical contact area is produced by metallization on a layer of the body of the resonator.

9. A system for measuring a property of a particle, comprising:
a mechanical resonator comprising an oscillating part,
excitation means configured to vibrate the oscillating part at an excitation frequency,
means for measuring an electrical signal at the output of the mechanical resonator,
wherein the mechanical resonator is as defined in claim 1.

10. The system according to claim 9, wherein the excitation means have a piezoceramic on which the mechanical resonator rests.
